(19) United States
(12) Patent Application Publication
(10) Pub. No.: US 2026/0246205 A1
(43) Pub. Date: Aug. 20, 2026

(54) TERMINAL ASSEMBLY AND SHIELDING STRUCTURE

(71) Applicant: DONGGUAN LEADER PRECISION INDUSTRY CO., LTD., Dongguan City (CN)

(72) Inventors: Zhongyuan LAI, Dongguan City (CN); Zhengguo SUN, Dongguan City (CN); Jinqi LI, Dongguan City (CN)

(73) Assignee: DONGGUAN LEADER PRECISION INDUSTRY CO., LTD., Dongguan City (CN)

(21) Appl. No.: 19/406,270

(22) Filed: Dec. 2, 2025

(30) Foreign Application Priority Data
Feb. 17, 2025 (CN) 202510173974.8

(51) Int. Cl. H01R 13/6585; H01R 13/04

(52) U.S. Cl. CPC H01R 13/6585; H01R 13/04

(57) ABSTRACT

The present application relates to a terminal assembly and a shielding structure. The terminal assembly includes a first terminal unit and a second terminal unit, wherein the first terminal unit includes a plurality of first terminals arranged side by side, and each of the first terminals has a first bent segment; and the second terminal unit includes a plurality of second terminals arranged side by side, and each of the second terminals has a second bent segment, wherein the first terminal unit and the second terminal unit are arranged opposite to form an anti-crosstalk space between a plurality of first bent segments and a plurality of second bent segments.

### CROSS-REFERENCE TO RELATED APPLICATION

The present application claims priority of Chinese Patent Application No. 202510173974.8 filed on Feb. 17, 2025 and entitled “Terminal Assembly, Shielding Structure, and Connector”, which is incorporated herein by reference in its entirety.

### FIELD

The present application relates to the technical field of electronic communications, and in particular, to a terminal assembly and a shielding structure.

### BACKGROUND

In order to achieve electrical connection and information exchange between electronic products, signal connection between two or more electronic products is often implemented through connectors. There is usually a single insulating tongue plate at an existing connector interface, and upper and lower rows of metal signal terminals are embedded on both sides of the insulating tongue plate to implement multi-channel signal transmission.

Due to the close arrangement of the plurality of signal terminals on the upper and lower sides of the insulating tongue plate, the spacing between the two rows of signal terminals is small. When signals on one or more of the signal terminals change, undesired voltage noise, i.e., crosstalk, will be generated on the adjacent signal terminals due to electromagnetic coupling.

The crosstalk will lead to distortion of signal waveforms. In high-speed signal transmission, the distortion may increase the signal error rate, thereby limiting the frequencies of signals that the connector may transmit.

### SUMMARY

An embodiment of the present application provides a terminal assembly, including: a first terminal unit, wherein the first terminal unit includes a plurality of first terminals arranged side by side, and each of the first terminals has a first bent segment; and a second terminal unit, wherein the second terminal unit includes a plurality of second terminals arranged side by side, and each of the second terminals has a second bent segment, wherein the first terminal unit and the second terminal unit are arranged opposite to form an anti-crosstalk space between a plurality of the first bent segments and a plurality of the second bent segments.

An embodiment of the present application provides a shielding structure, including the terminal assembly provided in the first aspect of the present application, and further including a first shielding member, wherein the first shielding member is arranged between the first terminal unit and the second terminal unit, and a portion of the first shielding member extends into the interior of the anti-crosstalk space.

An embodiment of the present application provides a shielding structure, including the terminal assembly provided in the first aspect of the present application, and further including a second shielding member and a third shielding member, wherein the second shielding member and the third shielding member are arranged on two outer sides of the anti-crosstalk space respectively.

### BRIEF DESCRIPTION OF THE DRAWINGS

FIG. 1 is a side view of a terminal assembly according to an embodiment of the present application;

FIG. 2 is a schematic structural diagram of a terminal assembly according to an embodiment of the present application;

FIG. 3 is a first schematic structural diagram of a first terminal according to an embodiment of the present application;

FIG. 4 is a second schematic structural diagram of a first terminal according to an embodiment of the present application;

FIG. 5 is a schematic diagram of a partial structure of a first terminal according to an embodiment of the present application;

FIG. 6 is a first schematic structural diagram of a shielding structure according to an embodiment of the present application;

FIG. 7 is a first schematic structural diagram of a first shielding member according to an embodiment of the present application;

FIG. 8 is a first partial cross-sectional view of a shielding structure according to an embodiment of the present application;

FIG. 9 is a second schematic diagram of a shielding structure according to an embodiment of the present application;

FIG. 10 is a second schematic structural diagram of a first shielding member according to an embodiment of the present application;

FIG. 11 is a second partial cross-sectional view of a shielding structure according to an embodiment of the present application;

FIG. 12 is a third schematic structural diagram of a shielding structure according to an embodiment of the present application;

FIG. 13 is a third schematic structural diagram of a first shielding member according to an embodiment of the present application;

FIG. 14 is a third partial cross-sectional view of a shielding structure according to an embodiment of the present application;

FIG. 15 is a fourth schematic structural diagram of a shielding structure according to an embodiment of the present application;

FIG. 16 is a side view of a shielding structure according to an embodiment of the present application;

FIG. 17 is a fifth schematic structural diagram of a shielding structure according to an embodiment of the present application;

FIG. 18 is a sixth schematic structural diagram of a shielding structure according to an embodiment of the present application;

FIG. 19 is a fourth partial cross-sectional view of a shielding structure according to an embodiment of the present application;

FIG. 20 is a first schematic structural diagram of a connector according to an embodiment of the present application;

FIG. 21 is a second schematic structural diagram of a connector according to an embodiment of the present application;

FIG. 22 is an enlarged detail view of part A in FIG. 21 according to an embodiment of the present application;

FIG. 23 is a schematic diagram of a partial structure of a connector according to an embodiment of the present application;

FIG. 24 is a front view of a connector according to an embodiment of the present application;

FIG. 25 is a cross-sectional view taken along line B-B in FIG. 24 according to an embodiment of the present application;

FIG. 26 is a cross-sectional view taken along line C-C in FIG. 24 according to an embodiment of the present application; and

FIG. 27 is an enlarged detail view of part D in FIG. 25 according to an embodiment of the present application.

### DETAILED DESCRIPTION

In order to make the objectives, technical solutions, and advantages of the embodiments of the present application clearer, the technical solutions in the embodiments of the present application will be described clearly and completely below in conjunction with the accompanying drawings therein. Apparently, the described embodiments are some of the embodiments of the present application, not all of them. Based on the embodiments of the present application, all other embodiments obtained by those of ordinary skill in the art without any creative effort shall fall within the scope of protection of the present application.

The following disclosure provides many different embodiments or examples to implement different structures of the present application. In order to simplify the disclosure of the present application, components and settings in specific examples are described below. Such components and settings are merely examples and are not intended to limit the scope of the present application. In addition, the present application may repeat reference numerals and/or letters in different examples. The repetition is for the purpose of simplification and clarity, and does not indicate the relationship between various discussed embodiments and/or settings.

For ease of description, spatial relative relationship terms can be used herein to describe the relative position or motion of one element or feature shown in the figures relative to the other element or feature. These relative relationship terms include "internal", "external", "inner", "outer", "below", "under", "on", "above", "front", "rear", etc. The spatial relative relationship terms are intended to include different orientations of an apparatus in use or operation, in addition to the orientations depicted in the figures. For example, if the apparatus in the figures undergoes a position flip, posture change, or motion state change, these directional indications also change accordingly. For example, one element described as "below the other element or feature" or "under the other element or feature" will subsequently be oriented as "on the other element or feature" or "above the other element or feature". Therefore, the exemplary term "under" may include both upper and lower orientations. The apparatus can be oriented otherwise (rotated 90 degrees or in other directions) and the spatial relative relationship descriptors used herein are explained accordingly.

In order to solve the technical problem of limitations on the frequencies of signals that existing connectors may transmit due to crosstalk between a plurality of signal terminals in the prior art, the present application provides a terminal assembly, a shielding structure, and a connector. In the terminal assembly, bent segments of two terminal units arranged opposite can form an anti-crosstalk space 3, which can increase the spacing between two rows of terminals arranged opposite. By increasing the spacing between the signal terminals, the coupling capacitance and mutual inductance effect between them can be reduced, thereby reducing the occurrence of crosstalk and facilitating the transmission of high-frequency signals by the connector.

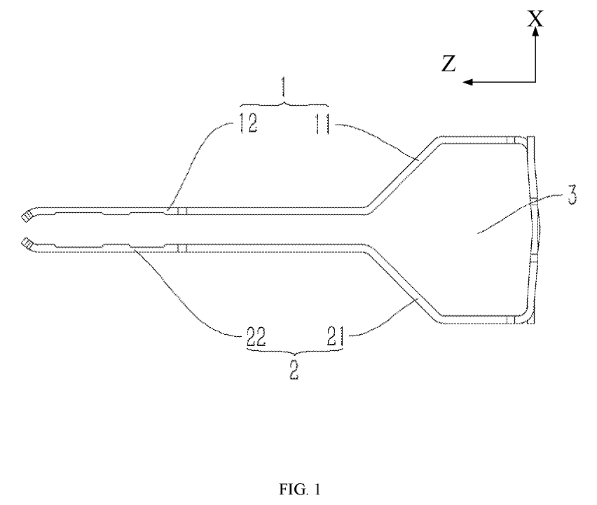

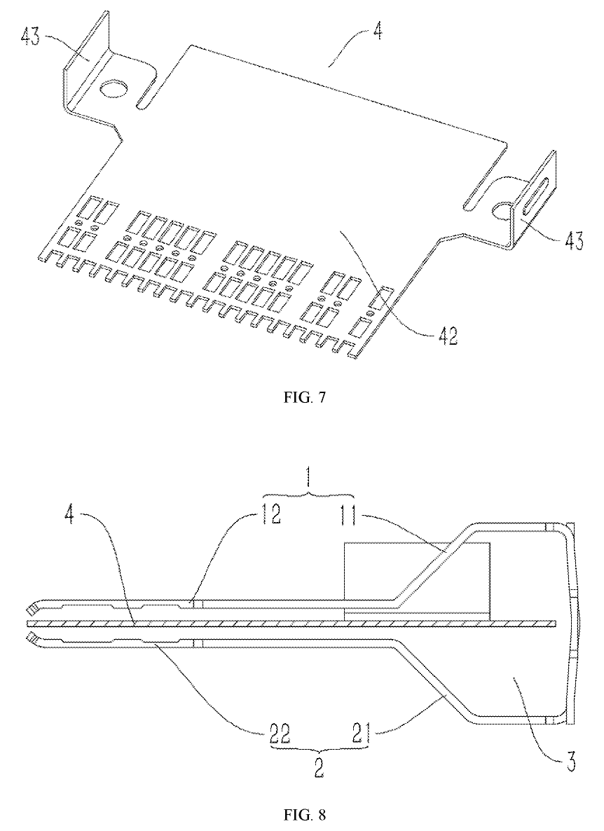

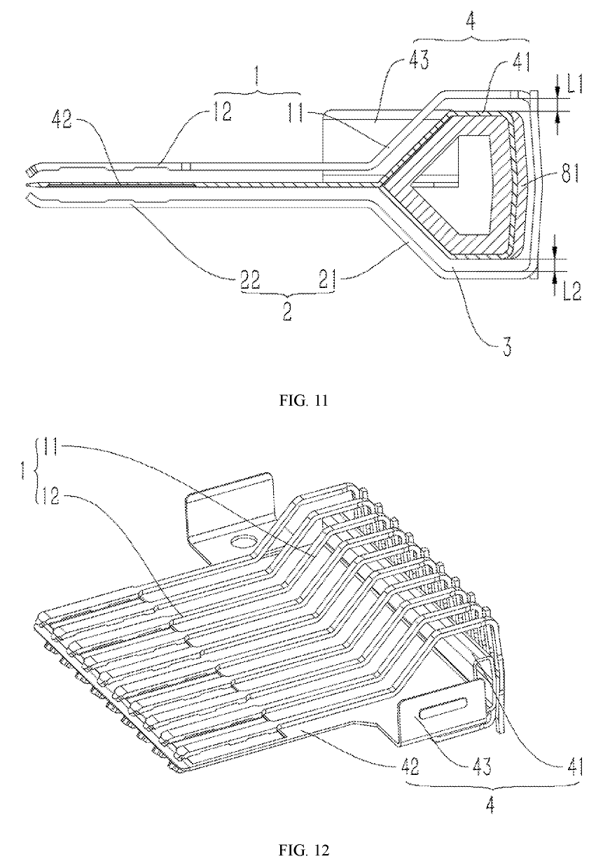

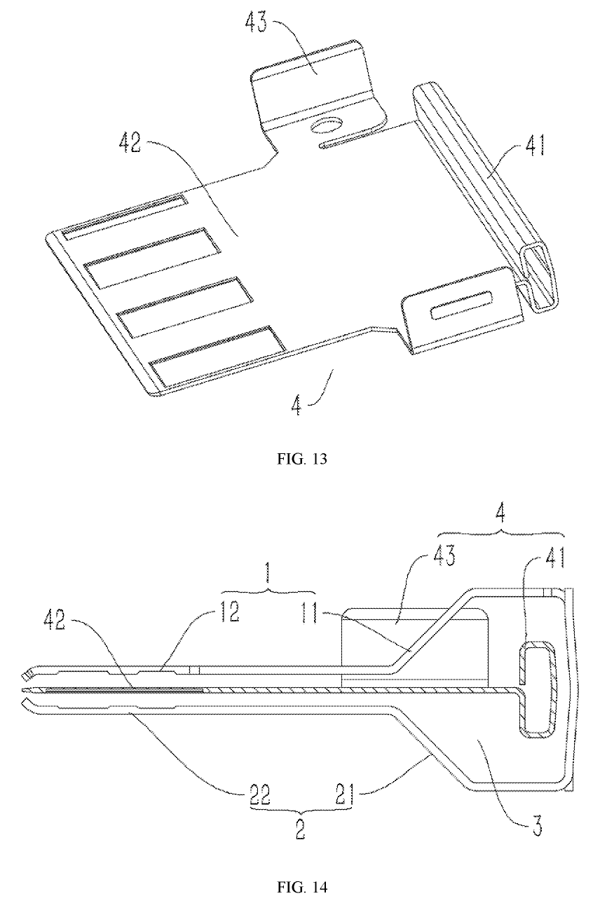

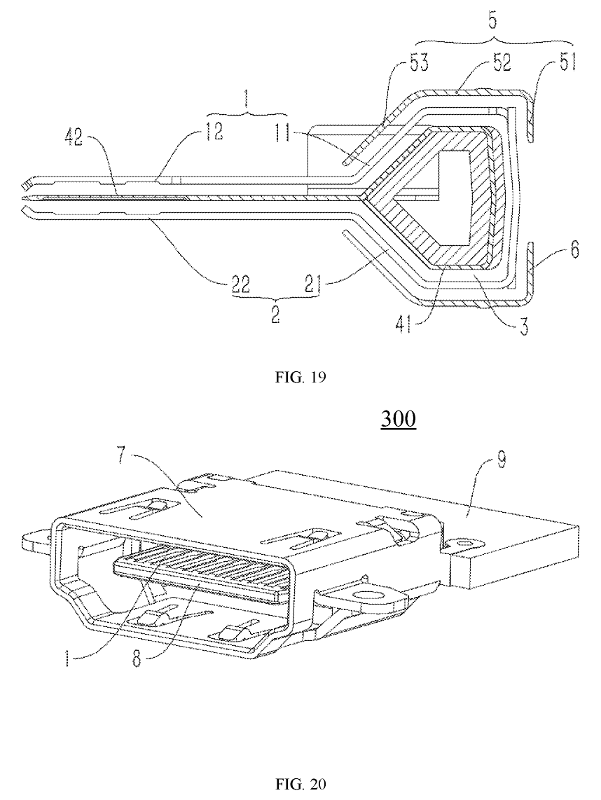

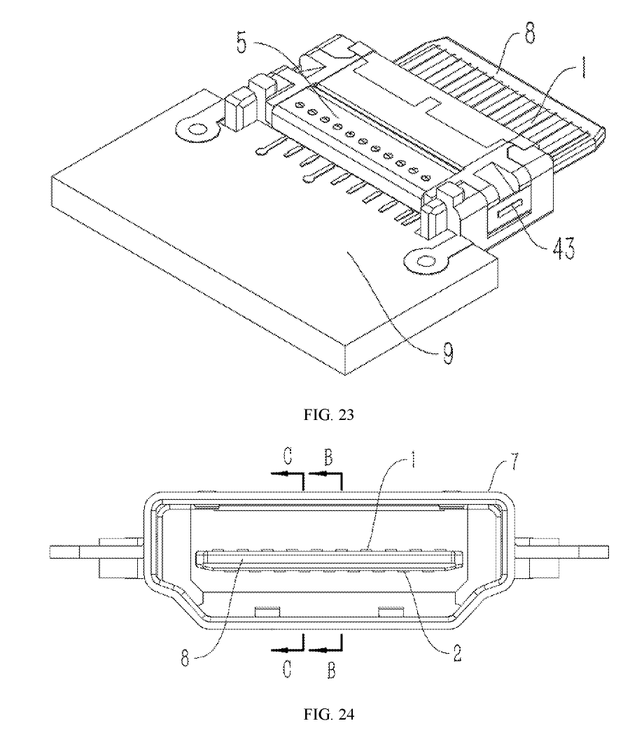

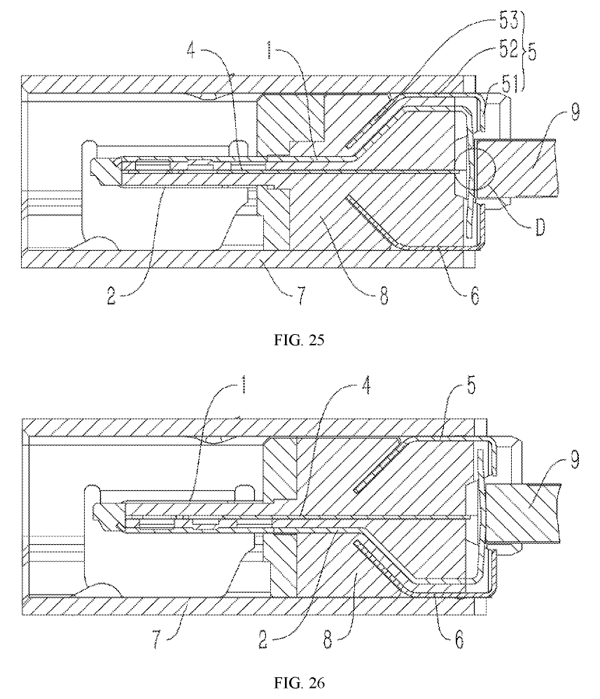

With reference to FIGS. 1 to 27, a first aspect of embodiments of the present application provides a terminal assembly 100, including a first terminal unit 101 and a second terminal unit 102, wherein the first terminal unit 101 includes a plurality of first terminals 1 arranged side by side, and each of the first terminals 1 has a first bent segment 11; the second terminal unit 102 includes a plurality of second terminals 2 arranged side by side, and each of the second terminals 2 has a second bent segment 21, as shown in FIGS. 1 to 5.

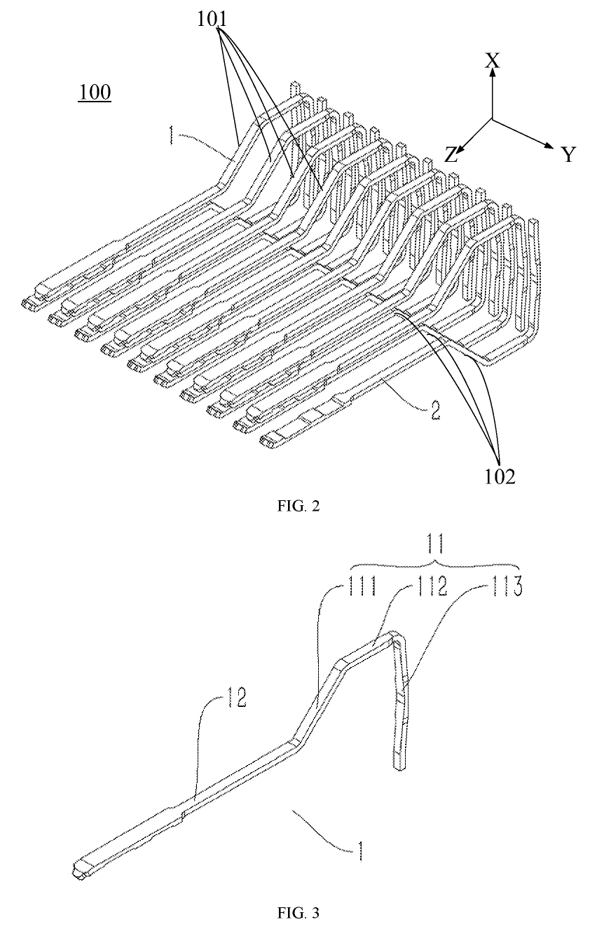

The first terminal unit and the second terminal unit are arranged opposite along a first direction. The spacing between the first terminal 1 and the second terminal 2 in the first direction may be increased through the first bent segment 11 and the second bent segment 21, so as to form an anti-crosstalk space 3 between the plurality of first bent segments 11 and the plurality of second bent segments 21. The anti-crosstalk space 3 can reduce the coupling capacitance and mutual inductance effect between the adjacent first terminal 1 and second terminal 2, thereby reducing the occurrence of crosstalk. Reducing the crosstalk can enhance signal integrity, ensure that signals are not disturbed during transmission, and help improve the communication quality of a connector, making the connector more suitable for high-precision, high reliability, and high-frequency transmission application scenarios. As shown in FIG. 2, the first direction is the direction indicated by X.

It should be noted that both the first terminal 1 and the second terminal 2 may be formed by a stamping process, and the bending shape and size of the first bent segment 11 and the second bent segment 21 may be designed according to the size requirements of the anti-crosstalk space 3. The crosstalk may decrease impedance matching accuracy, thereby affecting the efficiency and quality of signal transmission. The present application reduces crosstalk through the anti-crosstalk space 3, which can improve the impedance matching accuracy and ensure that signal can be accurately matched with desired impedance values during transmission.

In some embodiments of the present application, as show in FIGS. 1 and 2, the first bent segment 11 and the second bent segment 21 have an identical structure, and the first bent segment 11 and the second bent segment 21 orient opposite directions, enabling synchronous stamping of the first bent segment 11 and the second bent segment 21 and reducing processing steps of the first terminal unit and the second terminal unit. The first bent segment 11 and the second bent segment 21 opened in the opposite directions can enclose to form the vertically symmetrical anti-crosstalk space 3. In the length direction of the first terminal 1 or the second terminal 2, the trend of spacing changes between the first bent segment 11 and the second bent segment 21 may be relatively stable, avoiding sudden spacing changes and improving the anti-crosstalk effect of the anti-crosstalk space 3.

It should be noted that the front ends of the first terminal 1 and the second terminal 2 need to be fitted to an insulating tongue plate to facilitate the fixation and positioning of the first terminal 1 and the second terminal 2, so that the spacing between the first terminal 1 and the second terminal 2 needs to match the thickness of the insulating tongue plate. Therefore, the anti-crosstalk space 3 is preferably designed at tail ends of the first terminal unit and the second terminal unit.

In some embodiments of the present application, as shown in FIGS. 1 to 5, the first bent segment 11 is arranged at a tail end of the first terminal 1 (the end in a direction opposite to the Z direction in FIG. 1), and the second bent segment 21 is arranged at a tail end of the second terminal 2 (the end in the direction opposite to the Z direction in FIG. 1), avoiding affecting fit connection of the first terminal 1 and the second terminal 2 with the insulating tongue plate when the anti-crosstalk space 3 is formed at front ends of the first terminal 1 and the second terminal 2. Due to the identical structure of the first bent segment 11 and the second bent segment 21, the first bent segment 11 will be used as an example for structural description. As shown in FIG. 2, Z represents a third direction, and Y represents a second direction.

As shown in FIGS. 3, 4, and 5, the first bent segment 11 includes an inclined segment 111, a straight segment 112, and a first connecting segment 113 connected in sequence, wherein two ends of the straight segment 112 are connected at angles to the inclined segment 111 and the first connecting segment 113 respectively. When the first direction is a vertical direction, the first bent segment 11 may protrude upwards and the second bent segment 21 may protrude downwards, so as to increase the spacing between the first bent segment 11 and the second bent segment 21 below, thereby reducing crosstalk between the first terminal 1 and the adjacent second terminal 2. The first connecting segment 113 extends in the first direction and is used to connect with a circuit board 9, thereby achieving signal transmission between an electronic product connected to the connector and the circuit board 9.

It should be noted that the front end of the inclined segment 111 of the first bent segment 11 is connected to a second connecting segment 12 at the front end of the first terminal 1, and the rear end of the inclined segment 111 of the first bent segment 11 is connected to the straight segment 112. The spacing between the first terminal 1 and the second terminal 2 may be gradually increased through the inclined segment 111, thereby avoiding discontinuous trace impedance caused by sudden changes in the spacing between the first terminal 1 and the second terminal 2, to ensure the integrity of signals and the stability of a system.

In some embodiments of the present application, as shown in FIG. 5, the connection angle between the straight segment 112 and the inclined segment 111 is θ1, θ1 is preferably an obtuse angle, which can reduce stress at the connection between the straight segment 112 and the inclined segment 111, and θ1 is specifically 135°±10°. The connection angle between the straight segment 112 and the first connecting segment 113 is θ2, and θ2 is preferably between 90° and 100°, which facilitates the extension of the first connecting segment 113 in the vertical direction, thereby achieving signal connection between the first connecting segment 113 and the circuit board 9. The connection angle between the inclined segment 111 and the second connecting segment 12 is θ3, and preferably, θ3=θ1, which can ensure that the second connecting segment 12 (or the third connecting segment 22) is parallel to the straight segment 112, facilitating shape control of the first terminal 1 or the second terminal 2.

In some embodiments of the present application, as shown in FIGS. 1 to 5, when the first bent segment 11 and the second bent segment 21 are symmetrically arranged vertically, the anti-crosstalk space 3 is a pointed shuttle-shaped space, and the cross-section of the pointed shuttle-shaped space is approximately pentagonal. By adjusting the size of the pointed shuttle-shaped space, the impedance of the terminal assembly can be adjusted to be uniform, so that the impedance topology is basically balanced to reduce signal attenuation in the terminal assembly.

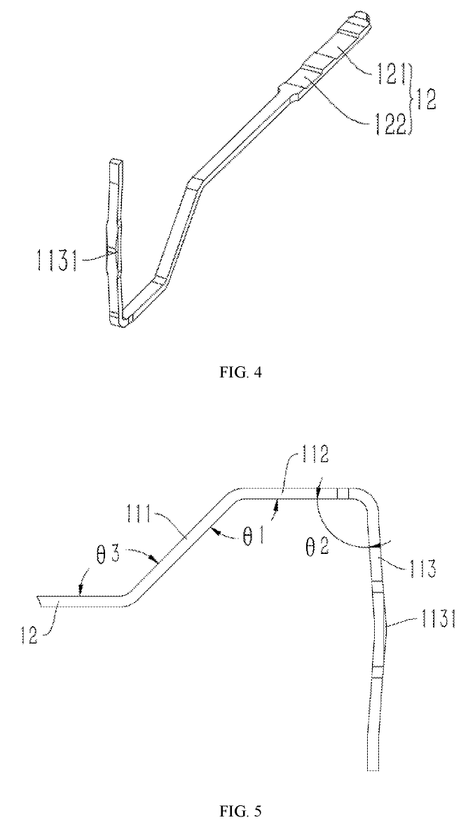

In some embodiments of the present application, as shown in FIGS. 4, 5, 21, 22, 25, and 27, the first connecting segment 113 has a protruding portion 1131, and the protruding portion 1131 is used to abut against a metal contact (i.e., a gold finger 92) on the circuit board 9, thereby achieving signal connection between the first terminal 1 or the second terminal 2 and the circuit board 9.

Because the first terminal 1 and the second terminal 2 are made of metal, the first bent segment 11 and the second bent segment 21 have elastic deformation capability. A plurality of gold fingers 92 (i.e., a plurality of metal contacts) are provided on one side of a substrate 91 of the circuit board 9. When the protruding portion 1131 of the first bent segment 11 or the second bent segment 21 abuts against the gold finger 92, the elastic force of the first bent segment 11 or the second bent segment 21 enables the protruding portion 1131 to tightly abut against the gold finger 92, thereby achieving adaptive elastic contact, avoiding separation between the first connecting segment 113 and the gold finger 92, avoiding connection failure between the terminal in the terminal assembly and the circuit board 9, and ensuring that electrical transmission and signal channels are connected normally.

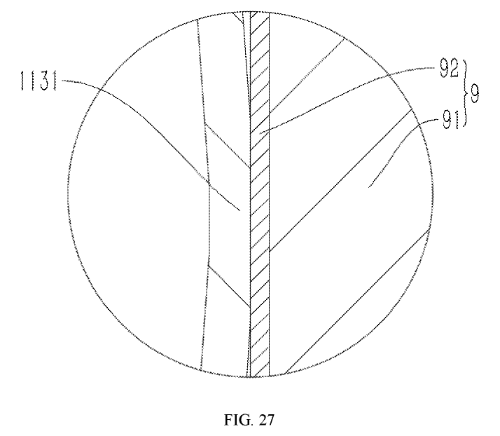

In some preferred embodiments of the present application, as shown in FIG. 27, the protruding portion 1131 has an arc-shaped guide surface on a side facing the circuit board 9. The circuit board 9 can move smoothly in the length direction of the arc-shaped guide surface, facilitating the adjustment of an abutting position between the circuit board 9 and the terminal assembly.

In some embodiments of the present application, as shown in FIG. 4, a plurality of grooves are provided on the second connecting segment 12 of the first terminal 1 (or on the third connecting segment 22 of the second terminal 2). The shape and quantity of the grooves may be designed as needed to prevent the terminal from loosening or falling off the insulating tongue plate, thereby improving connection reliability and ensuring stable and reliable signal transmission.

As a specific embodiment of the present application, with reference to FIG. 4, a first groove 121 and a second groove 122 are sequentially provided on the second connecting segment 12 of the first terminal 1, and the first groove 121 and the second groove 122 orient the insulating tongue plate in an insulating body 8, thereby improving the reliability of connection between the second connecting segment 12 and the insulating tongue plate, enhancing the stability and reliability of signal transmission, and ensuring accurate signal waveforms.

When the terminal assembly is applied to a connector, in order to protect the insulating tongue plate and the signal terminals, a metal shell 7 is provided on the periphery of the insulating tongue plate to protect the insulating tongue plate and the terminals and facilitate the insertion of the connector into an interface of an electronic device. However, the metal shell 7 is prone to introducing external electromagnetic interference into the signal terminals, which can damage the integrity of signal transmission of the connector, resulting in data loss or an increase in error rate.

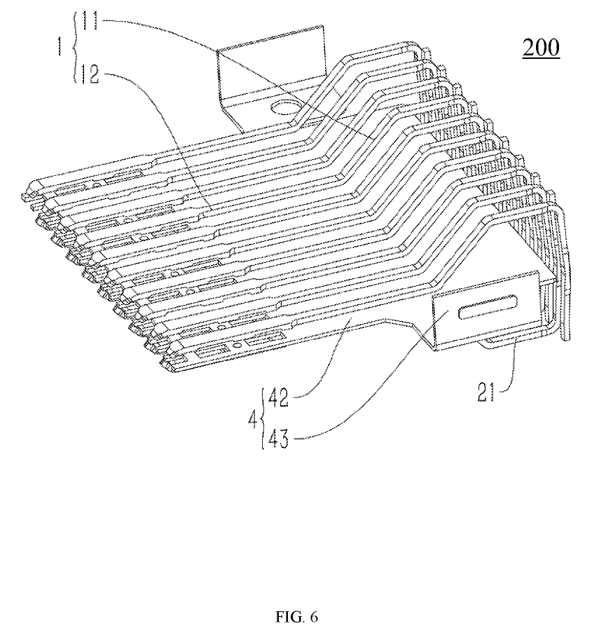

In order to solve the above problem, as shown in FIGS. 1 to 27, a second aspect of the embodiments of the present application provides a shielding structure 200, including the terminal assembly described in the foregoing embodiments, and further including a first shielding member 4, wherein the first shielding member 4 is used to electrically connect with the metal shell 7 of the connector, and the metal shell 7 is connected to the circuit board 9 to form a grounding circuit, so as to ensure an identical potential between the metal shell 7 and the first shielding member 4, and to prevent the metal shell 7 from introducing external electromagnetic interference into the first terminals 1 and the second terminals 2; the first shielding member 4 is arranged between the first terminal unit and the second terminal unit, and a portion of the first shielding member 4 extends into the interior of the anti-crosstalk space 3, as shown in FIGS. 6 to 14, to shield crosstalk electromagnetic waves between the first terminals 1 and the second terminals 2, and to absorb the crosstalk electromagnetic waves inside the anti-crosstalk space 3, thereby ensuring fast, smooth, and balanced signal transmission.

It should be noted that the first shielding member 4 is made of metal. In order to fix the first terminal unit, the first shielding member 4, and the second terminal unit in the connector, the first shielding member 4, the plurality of first terminals 1, and the plurality of second terminals 2 are all embedded in the insulating tongue plate of the insulating body 8, as shown in FIGS. 20, 24, 25, and 26. A tail end of the first shielding member 4 extends into the anti-crosstalk space 3, to absorb the crosstalk electromagnetic waves inside the anti-crosstalk space 3.

In some embodiments of the present application, as shown in FIGS. 6 to 8, the main body of the first shielding member 4 is a plate structure (i.e., a plate portion 42), so that the spacing between the tail end of the first shielding member 4 and the straight segment 112 is relatively large, leading to poor absorption of crosstalk electromagnetic waves in a corresponding area of the straight segment 112 by the tail end of the first shielding member 4.

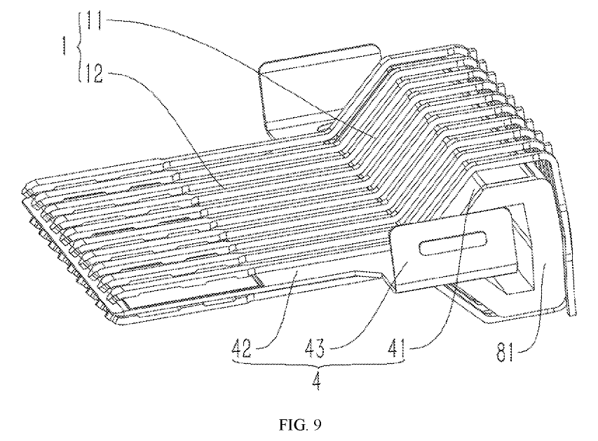

In order to solve the above problem, in some embodiments of the present application, as shown in FIGS. 9 to 14, the first shielding member 4 includes a tubular portion 41, the tubular portion 41 is located inside the anti-crosstalk space 3, there is a first preset spacing L1 between the tubular portion 41 and the first bent segment 11, and there is a second preset spacing L2 between the tubular portion 41 and the second bent segment 21. This shortens the distance between the metal plate of the tubular portion 41 and the first bent segment 11 and/or the second bent segment 21, thereby improving the absorption effect of the crosstalk electromagnetic waves inside the anti-crosstalk space 3 by the tail end of the first shielding member 4.

It should be noted that the cross-sectional shape and size of the tubular portion 41 may be designed according to the requirements of impedance matching. The cross-section of the tubular portion 41 may be rectangular, elliptical, polygonal, etc. The tubular portion 41 may be embedded in an insulating tube 81 of the insulating body 8, as shown in FIGS. 9 to 14. As long as the crosstalk electromagnetic waves inside the anti-crosstalk space 3 can be absorbed, such practices can achieve the objective of the present application.

In some preferred embodiments of the present application, as shown in FIGS. 9, 10, and 11, the shape of the tubular portion 41 is matched with the shape of the anti-crosstalk space 3, that is, the cross-sectional shape of the tubular portion 41 is the same as the cross-sectional shape of the anti-crosstalk space 3, and the both are concentric (i.e., their cross-sectional centers coincide). At different positions in the circumferential direction of the anti-crosstalk space 3, the spacing between the outer wall of the tubular portion 41 and plate bodies of the opposite bent segments may be the same or approximately the same. Through balanced absorption of crosstalk electromagnetic waves at various positions in the circumferential direction of the bent segments (i.e., the first bent segments 11 and the second bent segments 21) by the tubular portion 41, the shielding effect of the tubular portion 41 on the anti-crosstalk space 3 is enhanced.

In some embodiments of the present application, as shown in FIGS. 9 to 14, the first shielding member 4 further includes a plate portion 42, the plate portion 42 is embedded in the insulating tongue plate at the front end of the insulating body 8, and the plate portion is used to shield and absorb the crosstalk electromagnetic waves between the second connecting segment 12 and the third connecting segment 22. The plate portion 42 is electrically connected to the tubular portion 41, so that the plate portion 42 and the tubular portion 41 are connected into one shielding piece, which is then electrically connected to the metal shell 7 to shield the crosstalk electromagnetic waves of the terminal assembly.

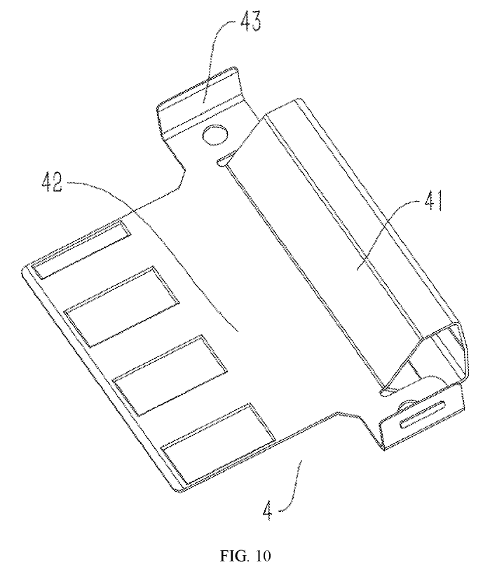

In the above embodiments, the plate portion 42 and the tubular portion 41 may be designed separately and then connected into one piece through assembly, but the assembly process is relatively complicated. Therefore, in some preferred embodiments of the present application, as shown in FIGS. 10, 11, 13, and 14, the plate portion 42 and the tubular portion 41 are of a one-piece connection structure. The tubular portion 41 may be made by bending the tail end of a metal plate body repeatedly, thereby reducing the difficulty in making the first shielding member 4 and improving the reliability of connection between the plate portion 42 and the tubular portion 41.

In some embodiments of the present application, as shown in FIGS. 6 to 14, the first shielding member 4 is further provided with an ear plate portion 43, and the ear plate portion 43 is used to abut against the inner wall of the metal shell 7. When the first shielding member 4 is assembled with the insulating body 8, the ear plate portion 43 is exposed to the insulating body 8, to achieve electrical connection through the abutment between the ear plate portion 43 and the inner wall of the metal shell 7, thereby grounding the crosstalk electromagnetic waves. The ear plate portion 43 may be arranged on one side or both sides of the first shielding member 4, to achieve the objective of the present application.

As a specific embodiment of the present application, two ear plate portions 43 are symmetrically arranged on left and right sides of the first shielding member 4, to abut against the inner walls of the metal shell 7 on left and right sides and achieve grounding transmission of electromagnetic waves, thereby blocking external electromagnetic interference from entering the signal transmission system, helping to protect the internal signals of the system from external noise interference, and improving the accuracy and stability of signal transmission.

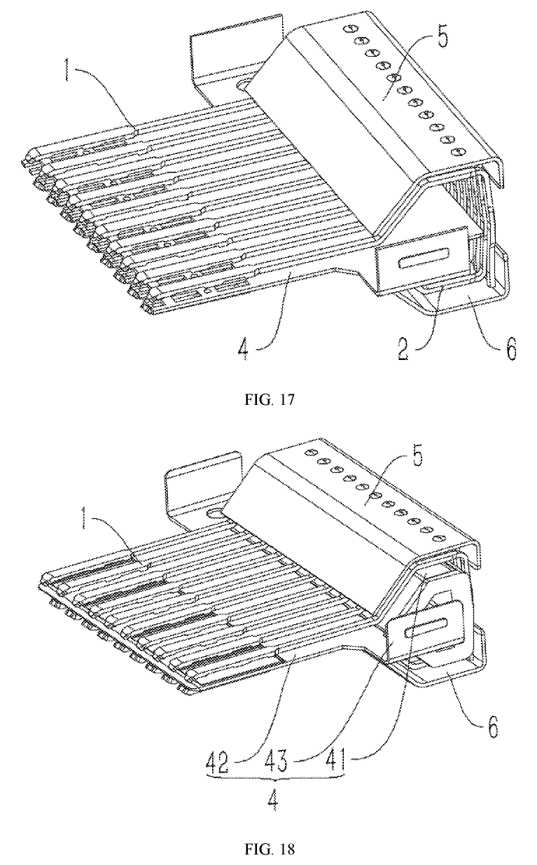

In some embodiments of the present application, as shown in FIGS. 17, 18, 19, 24, 25, and 26, the shielding structure 200 further includes a second shielding member 5 and a third shielding member 6, wherein the second shielding member 5 and the third shielding member 6 are arranged on two outer sides of the anti-crosstalk space 3 respectively and electrically connected to the metal shell 7 of the connector, so that the second shielding member 5 and the third shielding member 6 have the same potential as the metal shell 7, thereby shielding crosstalk electromagnetic waves outside the anti-crosstalk space 3 (i.e., outside the first bent segments 11 and the second bent segments 21), and preventing the metal shell 7 from introducing external crosstalk into the first terminals 1 and the second terminals 2.

With reference to FIGS. 1 to 27, a third aspect of the embodiments of the present application provides a shielding structure 200, including the terminal assembly described in the foregoing embodiments, and further including a second shielding member 5 and a third shielding member 6, wherein the second shielding member 5 and the third shielding member 6 are arranged on two outer sides of the anti-crosstalk space 3 respectively and electrically connected to the metal shell 7 of the connector, so that the second shielding member 5 and the third shielding member 6 have the same potential as the metal shell 7, thereby shielding crosstalk electromagnetic waves outside the anti-crosstalk space 3 (i.e., outside the first bent segments 11 and the second bent segments 21), and preventing the metal shell 7 from introducing external crosstalk into the first terminals 1 and the second terminals 2. This shielding structure differs from the shielding structure provided in the second aspect of the present application in that the first shielding member 4 is not provided between the first terminal unit and the second terminal unit, and only the second shielding member 5 and the third shielding member 6 are provided to shield the crosstalk electromagnetic waves outside the first terminal unit and the second terminal unit.

It should be noted that the second shielding member 5 and the third shielding member 6 are made of metal plates. In order to fix the second shielding member 5 and the third shielding member 6, a portion of the second shielding member 5 and a portion of the third shielding member 6 are connected to the insulating body 8, wherein the connection may be embedded connection or bonding, both of which can achieve the objective of the present application.

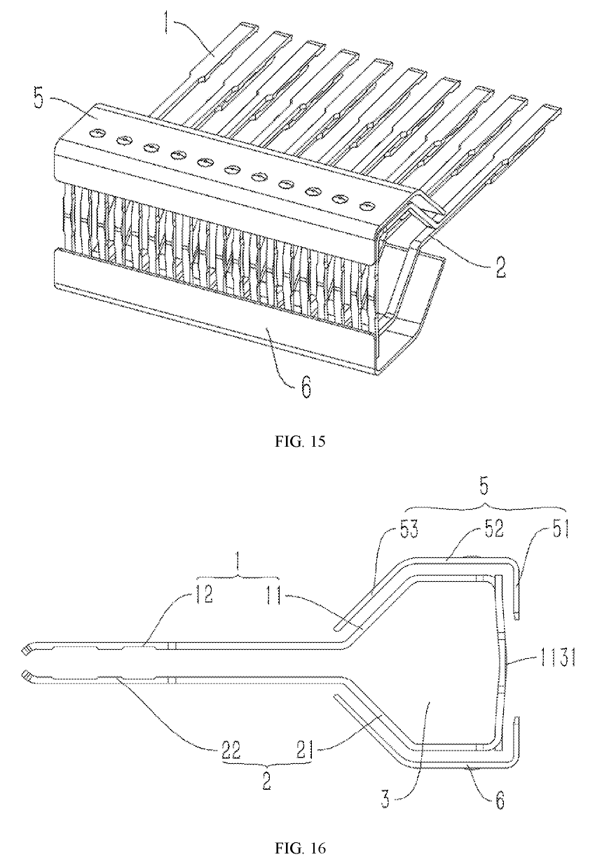

In some embodiments of the present application, as shown in FIGS. 15 and 16, the second shielding member 5 is matched with the first bent segments 11 to shield electromagnetic waves outside the tail ends of the plurality of first terminals 1 on the upper layer, and the third shielding member 6 is matched with the second bent segments 21 to shield electromagnetic waves outside the tail ends of the plurality of second terminals 2 on the lower layer. By combining the second shielding member 5 and the third shielding member 6 to form a pointed shuttle-shaped bidirectional signal protection structure, which can avoid faults or inconsistencies in the signal terminal circuit, completely shield external crosstalk electromagnetic waves, and ensure fast, smooth, and balanced signal transmission.

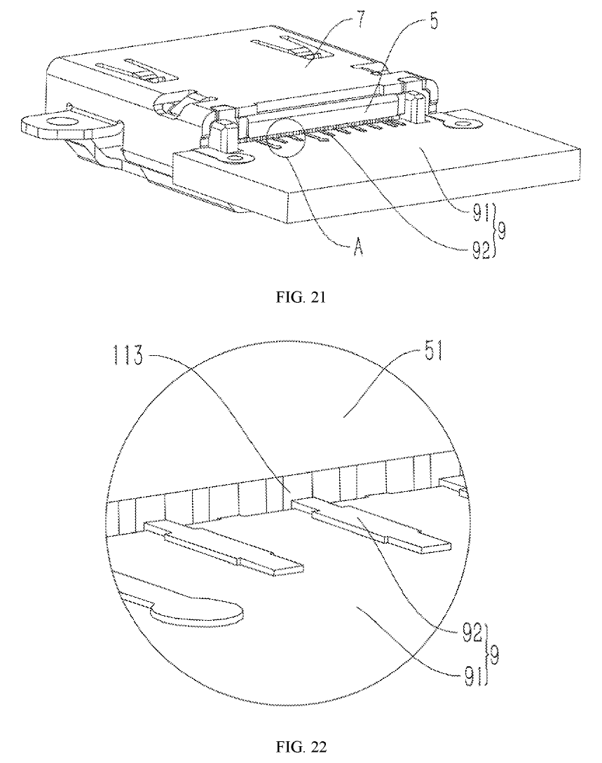

In some embodiments of the present application, as shown in FIGS. 15 and 16, the second shielding member 5 and the third shielding member 6 have the same structure and opposite orientations, forming a vertically symmetrical pointed shuttle-shaped bidirectional signal protection structure. Taking the second shielding member 5 as an example for structural explanation: The second shielding member 5 includes a first plate body 51 and a second plate body 52 connected at an angle, wherein the first plate body 51 extends in the first direction and is used to shield the first connecting segment 113 of the first terminal 1 or the second terminal 2, and only the protruding portion 1131 is exposed between gaps of the first plate body 51 on upper and lower sides, whereby the tail end of the terminal is wrapped and shielded and the abutment between the protruding portion 1131 and the circuit board 9 is facilitated, as shown in FIGS. 21, 22, and 23.

In some embodiments of the present application, the connection angle between the second plate body 52 and the first plate body 51 is the same as θ2, enabling the first plate 51 to shield the first connecting segment 113 and the second plate body 52 to shield the straight segment 112.

In some embodiments of the present application, as shown in FIGS. 15 and 16, the second shielding member 5 further includes a third plate body 53, the third plate body 53 is embedded in the insulating body 8, and the third plate body 53 has the same inclination angle as the corresponding inclined segment 111 to shield the inclined segment 111 in the bent segment.

It should be noted that the second shielding member 5 and the third shielding member 6 in the foregoing embodiments of the present application are also applicable to the shielding structure provided in the second aspect of the present application. As shown in FIGS. 17, 18, 19, and 23 to 26, the second shielding member 5 and the third shielding member 6 may be combined with the first shielding member 4 to form an all-directional shielding structure. The first shielding member 4 absorbs internal crosstalk electromagnetic waves between the first terminals 1 and the second terminals 2, and the second shielding member 5 and the third shielding member 6 shield crosstalk electromagnetic waves outside the first terminals 1 and the second terminals 2, thereby significantly improving the stability of signal transmission, enhancing the signal shielding effect, and improving the reliability of a system.

With reference to FIGS. 1 to 27, a fourth aspect of the embodiments of the present application provides a connector 300, including the terminal assembly described in the foregoing embodiments. Since the anti-crosstalk space 3 is provided at the tail end of the terminal assembly, the spacing between the tail ends of the adjacent first terminal 1 and second terminal 2 may be increased. The increase in spacing directly enlarges the anti-crosstalk space 3 at the tail end. This spatial change reduces the overlap and interaction of electromagnetic fields, effectively weakens electromagnetic field interaction between differential pairs, and reduces the possibility of crosstalk between the differential pairs. This means that the interference from adjacent signal lines to the differential pairs is greatly reduced when transmitting signals, thereby achieving the technical effect of little crosstalk, and making the connector of the present application more suitable for high-precision, high-reliability, and high-frequency transmission application scenarios, as shown in FIGS. 20 to 26.

In some embodiments of the present application, as shown in FIGS. 24 to 26, the connector includes the shielding structure provided in the second aspect of the present application, wherein the first shielding member 4 absorbs internal crosstalk electromagnetic waves between the first terminals 1 and the second terminals 2, thereby further improving the anti-crosstalk performance of the connector. On this basis, the second shielding member 5 and the third shielding member 6 may be arranged on two outer sides of the anti-crosstalk space 3 respectively to further shield external crosstalk electromagnetic waves, ensuring fast, smooth, and balanced signal transmission.

In some embodiments of the present application, the connector includes the shielding structure provided in the third aspect of the present application, wherein the second shielding member 5 and the third shielding member 6 form a pointed shuttle-shaped bidirectional signal protection structure, which can avoid faults or inconsistencies in the signal terminal circuit, substantially balance the impedance topology, and achieve approximately consistent impedance matching. In the absence of the first shielding member 4 in this connector, only the second shielding member 5 and the third shielding member 6 are embedded on the upper and lower sides of the insulating body 8, which can reduce the assembly difficulty of the shielding structure in the connector and lower the manufacturing cost of the connector.

It should be understood that the terms used herein are only for the purpose of describing specific exemplary implementations and are not intended to be restrictive. Unless otherwise explicitly stated in the context, singular forms such as "a", "one", and "the" used herein may further include plural forms. The terms "comprise", "include", "contain", and "have" are inclusive and therefore indicate the existence of the stated features, steps, operations, elements, and/or components, but do not exclude the existence or addition of one or more other features, steps, operations, elements, components, and/or combinations thereof. The method steps, processes, and operations described herein are not interpreted as requiring them to be executed in a specific order described or illustrated, unless an execution order is clearly indicated. It should also be understood that additional or alternative steps can be used.

Although the terms first, second, third, etc. can be used herein to describe a plurality of elements, components, regions, layers, and/or segments, these elements, components, regions, layers, and/or segments should not be limited by these terms. These terms can only be used for distinguishing one element, component, region, layer, or segment from another. Unless explicitly stated in the context, the terms such as "first" and "second" and other numerical terms used herein do not imply order or sequence. Therefore, the first element, component, region, layer, or segment discussed below may be referred to as the second element, component, region, layer, or segment without departing from the teachings of the example embodiments.

Described above are merely specific implementations of the present application, enabling a person skilled in the art to understand or implement the present application. Various modifications to these embodiments are apparent to the person skilled in the art. General principles defined herein may be implemented in other embodiments without departing from the spirit or scope of the present application. Therefore, the present application will not be limited to these embodiments shown herein, but will conform to the widest scope consistent with the principle and novelty of the present application.

What is claimed is:

1. A terminal assembly, comprising:
a first terminal unit, wherein the first terminal unit comprises a plurality of first terminals arranged side by side, and each of the first terminals has a first bent segment; and
a second terminal unit, wherein the second terminal unit comprises a plurality of second terminals arranged side by side, and each of the second terminals has a second bent segment, wherein the first terminal unit and the second terminal unit are arranged opposite to form an anti-crosstalk space between a plurality of the first bent segments and a plurality of the second bent segments.

2. The terminal assembly according to claim 1, wherein the first bent segment and the second bent segment have an identical structure, and the first bent segment and the second bent segment orient opposite directions.

3. The terminal assembly according to claim 2, wherein the first bent segment is arranged at a tail end of the first terminal, and the first bent segment comprises an inclined segment, a straight segment, and a first connecting segment connected in sequence, wherein two ends of the straight segment are connected at angles to the inclined segment and the first connecting segment respectively; and
the first connecting segment extends in a first direction and is used to connect with a circuit board.

4. The terminal assembly according to claim 3, wherein the first connecting segment has a protruding portion, and the protruding portion is used to abut against a metal contact on the circuit board.

5. The terminal assembly according to claim 1, wherein the terminal assembly is mounted in a connector.

6. A shielding structure, comprising the terminal assembly according to claim 1 and a first shielding member, wherein the first shielding member is arranged between the first terminal unit and the second terminal unit, and a portion of the first shielding member extends into the interior of the anti-crosstalk space.

7. The shielding structure according to claim 6, wherein the first shielding member comprises a tubular portion, the tubular portion is located inside the anti-crosstalk space, there is a first preset spacing between the tubular portion and the first bent segment, and there is a second preset spacing between the tubular portion and the second bent segment.

8. The shielding structure according to claim 7, wherein the shape of the tubular portion is matched with the shape of the anti-crosstalk space.

9. The shielding structure according to claim 7, wherein the first shielding member further comprises a plate portion, and the plate portion is electrically connected to the tubular portion.

10. The shielding structure according to claim 9, wherein the plate portion and the tubular portion are of a one-piece connection structure.

11. The shielding structure according to claim 6, further comprising a second shielding member and a third shielding member, wherein the second shielding member and the third shielding member are arranged on two outer sides of the anti-crosstalk space respectively.

12. The shielding structure according to claim 7, further comprising a second shielding member and a third shielding member, wherein the second shielding member and the third shielding member are arranged on two outer sides of the anti-crosstalk space respectively.

13. The shielding structure according to claim 8, further comprising a second shielding member and a third shielding member, wherein the second shielding member and the third shielding member are arranged on two outer sides of the anti-crosstalk space respectively.

14. The shielding structure according to claim 9, further comprising a second shielding member and a third shielding member, wherein the second shielding member and the third shielding member are arranged on two outer sides of the anti-crosstalk space respectively.

15. The shielding structure according to claim 6, wherein the shielding structure is mounted in a connector, and the first shielding member is electrically connected to a metal shell of the connector.

16. A shielding structure, comprising the terminal assembly according to claim 1, a second shielding member and a third shielding member, wherein the second shielding member and the third shielding member are arranged on two outer sides of the anti-crosstalk space respectively.

17. The shielding structure according to claim 16, wherein the second shielding member is matched with the first bent segment, and the third shielding member is matched with the second bent segment.

18. The shielding structure according to claim 16, wherein the second shielding member and the third shielding member have an identical structure; and the second shielding member comprises a first plate and a second plate connected at an angle, wherein the first plate extends in the first direction and is used to shield the first connecting segment of the first terminal or the second terminal.

19. The shielding structure according to claim 17, wherein the second shielding member and the third shielding member have an identical structure; and the second shielding member comprises a first plate and a second plate connected at an angle, wherein the first plate extends in the first direction and is used to shield the first connecting segment of the first terminal or the second terminal.

20. The shielding structure according to claim 16, wherein the shielding structure is mounted in a connector, and the second shielding member and the third shielding member are electrically connected to a metal shell of the connector.
